(19) United States
(12) Patent Application Publication
(10) Pub. No.: US 2007/0073600 A1
(43) Pub. Date: Mar. 29, 2007

(54) Floor plan finance serial number tracking system and method

(76) Inventor: Corey L. Holton, Portland, OR (US)

Correspondence Address: GRAYBEAL, JACKSON, HALEY LLP, 155 - 108TH AVENUE NE, SUITE 350, BELLEVUE, WA, 98004-5901, US

(21) Appl. No.: 11/488,446

(22) Filed: Jul. 17, 2006

Related U.S. Application Data
(60) Provisional application No. 60/699,964, filed on Jul. 15, 2005.

(51) Int. Cl. G06Q 10/00

(52) U.S. Cl. 705/28

(57) ABSTRACT

A method and system for selling a product or service to a lead and generating an income statement including entries associated with an order placed by the lead includes receiving information from a lead. A pre-sale marketing campaign stream is assigned to the lead based upon the received information, with the marketing campaign including a predetermined schedule and predetermined actions for following up with the lead. The lead is contacted according to the predetermined schedule and once the lead places an order a post-sale marketing campaign stream is assigned to the lead. The post-sale marketing campaign stream also includes a predetermined schedule and predetermined actions for following up with the lead. Once the lead places the order, an income statement including entries associated with the order is generated and the lead is contacted according to the predetermined schedule of the post-sale marketing campaign stream.

### PRIORITY CLAIM

This application claims priority from U.S. Provisional Application No. 60/699,964, filed Jul. 15, 2005, which is incorporated herein by reference.

### TECHNICAL FIELD

The present invention relates generally to computer programs, and more specifically to business computer programs for performing various tasks associated with running a business.

### BACKGROUND OF THE INVENTION

A myriad of software packages or computer programs are available for use by a business owner in running a business. These programs range from complex custom software packages developed for vary large corporations to meet specific business needs to retail software packages that a small business owner may purchase at a local store and then utilize in running his or her business. For example, a small business owner may purchase a retail accounting software package to handle the accounting for his business, an inventory management software package to assist the owner in managing his inventory, and a marketing software package to assist in marketing for the business.

Some presently available software packages may be termed “integrated” packages in that these software packages integrate functionality required to handle various key aspects of a business, such as accounting, inventory management, customer service, point of sale, payroll, and sales force functionality. Ideally, a software package would provide functionality for all key aspects of a business from marketing efforts to identify customer prospects or leads through delivery of a product or service to customer. Some software packages provide marketing functionality for tracking the success of marketing efforts to determine, for example, return on investment (ROI) of advertising efforts. Some packages also gather customer profile information to allow marketing personnel to develop future marketing efforts targeted to existing customers based upon this profile information. Such packages are, however, focused on existing customers of the business and not prospective customers or leads and do not provide functionality for all business processes between identification of a lead through a sale of product to that lead and the corresponding entries in financial statements for this sale.

There is a need for an integrated system and method for providing comprehensive functionality for all business processes from the generation of leads via marketing efforts through the preparation of financial statements containing entries for sales of products or services to such leads.

### SUMMARY OF THE INVENTION

According to one aspect of the present invention, a method and system for selling a product or service to a lead and generating an income statement including entries associated with an order placed by the lead includes receiving information from a lead. A pre-sale marketing campaign stream is assigned to the lead based upon the received information, with the marketing campaign including a predetermined schedule and predetermined actions for following up with the lead. The lead is contacted according to the predetermined schedule and once the lead places an order a post-sale marketing campaign stream is assigned to the lead. The post-sale marketing campaign stream also includes a predetermined schedule and predetermined actions for following up with the lead. Once the lead places the order, an income statement including entries associated with the order is generated and the lead is contacted according to the predetermined schedule of the post-sale marketing campaign stream.

### BRIEF DESCRIPTION OF THE DRAWINGS

FIG. 1 is a functional block diagram of a computer system including processing circuitry for executing a business management computer program that implements a lead-to-income statement process according to one embodiment of the present invention.

FIGS. 2-5 are screens rendered by the business management computer program for the four main functional components of the program according to one embodiment of the present invention.

FIGS. 6A and 6B depict a flowchart of the lead-to-income statement process executed by the business management computer program of FIG. 2 according to one embodiment of the present invention.

FIGS. 7A-7C illustrate windows displayed by the business management computer program of FIG. 1 to allow a user to input a new lead into the program during the process of FIGS. 6A and 6B.

FIG. 8 illustrates a window showing follow up steps of a sample marketing campaign stream for the process of FIGS. 6A and 6B.

FIG. 9 illustrates a window presented to a user for providing a lead with a quotation during the process of FIGS. 6A and 6B.

FIG. 10 FIG. 10 is an example of a window showing the generation of a sales order during the process of FIGS. 6A and 6B.

FIG. 11 illustrates a sample income statement generated by the process of FIGS. 6A and 6B.

### DETAILED DESCRIPTION OF PREFERRED EMBODIMENTS

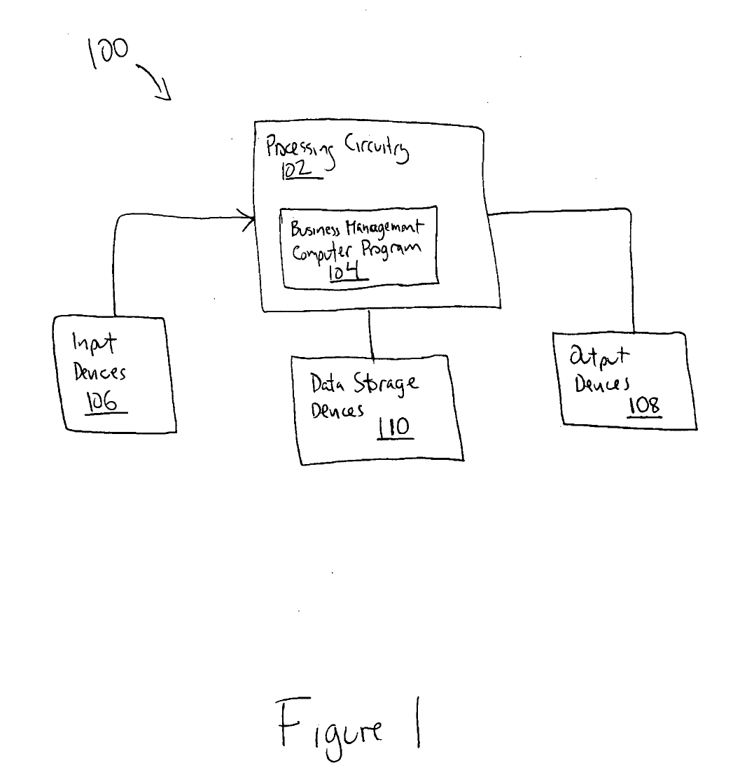

FIG. 1 is a functional block diagram of a computer system 100 including processing circuitry 102 for executing a business management computer program 104 that implements a lead-to-income statement process according to one embodiment of the present invention. In operation, the computer program 104 renders screens, prompts users for input, and generates reports to implement a lead-to-income statement process that includes all business processes from the time a lead is acquired or input to the program through the generating of an income statement for a business, with the income statement containing an entry or entries corresponding to products or services purchased by the lead that is now a customer, as will be described in more detail below. The computer program 104 also provides functionality to allow a business owner or manager to handle all key business processes associated with the business, as will also be explained in more detail below.

In the following description, certain details are set forth in conjunction with the described embodiments of the present invention to provide a sufficient understanding of the invention. One skilled in the art will appreciate, however, that the invention may be practiced without these particular details. Furthermore, one skilled in the art will appreciate that the example embodiments described below do not limit the scope of the present invention, and will also understand that various modifications, equivalents, and combinations of the disclosed embodiments and components of such embodiments are within the scope of the present invention. Embodiments including fewer than all the process steps of any of the respective described embodiments may also be within the scope of the present invention although not expressly described in detail below. Finally, the operation of well known components and/or processes has not been shown or described in detail below to avoid unnecessarily obscuring the present invention.

The computer system 100 includes one or more input devices 106, such as a keyboard or a mouse, coupled to the processing circuitry 102 to allow an operator to interface with the computer system. Typically, the computer system 100 also includes one or more output devices 108 coupled to the processing circuitry 102, such output devices typically including a printer and a video terminal. One or more data storage devices 110 are also typically coupled to the processing circuitry 102 to store data or retrieve data from external storage media (not shown). Examples of typical storage devices 110 include hard and floppy disks, tape cassettes, compact disk read-only (CD-ROMs) and compact disk read-write (CD-RW) memories, and digital video disks (DVDs).

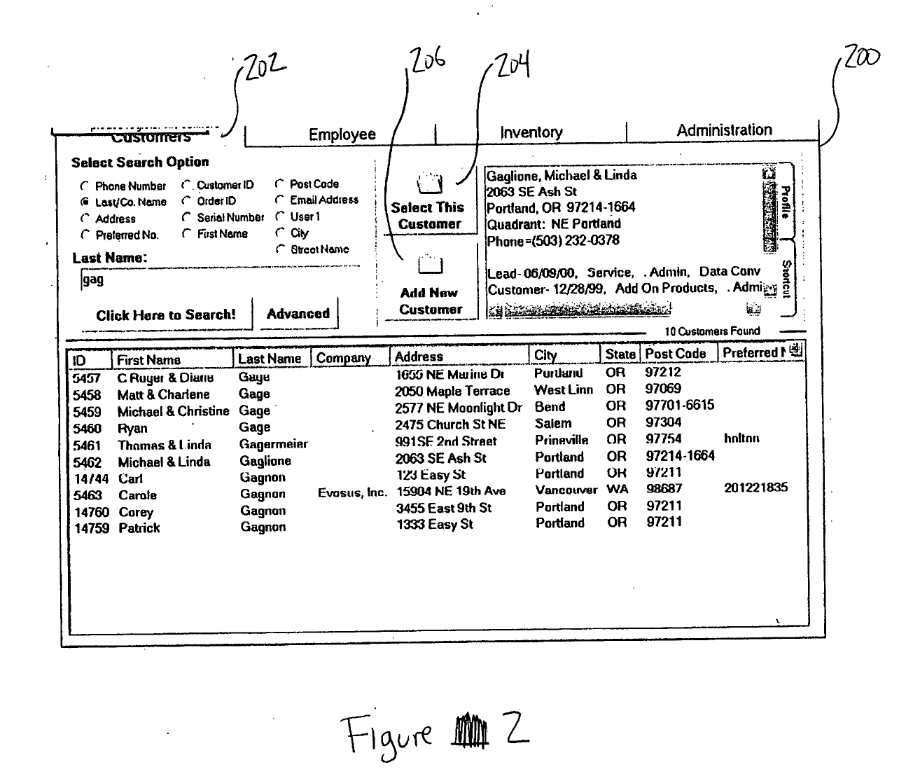

Before describing an embodiment of a lead-to-income statement process executed by the program 104, a general overall description of the program will be described with reference to FIGS. 2-5 showing screens rendered by the computer program for the four main functional components of the program. These four main functional components are the customers, employee, inventory, and administration components, which are illustrated in FIGS. 2-5, respectively. FIG. 2 illustrates a main menu 200 for the customer component of the program 104. The main menu for each of the functional components may be accessed through a corresponding tab at the top of each main menu, with a tab 202 being selected to select the main menu for the customer component in FIG. 2.

Through the upper left portion of the main menu 200, a user of the program 104 can enter a search query to search for a desired customer or lead in a database (not shown) generated by the program. Customers and leads found in the database for a given search query are shown in the lower portion of the main menu 200. More detailed information for a selected one of the customers displayed in the lower portion of the main menu 200 is shown in the upper right portion of the main menu, as illustrated for sample customers Gaglione, Michael & Linda in FIG. 2. A select this customer tab 204 may be selected to perform any desired action on the selected customer, such as adding a new interest, adding a new quote, and so on, as will be discussed in more detail below. For a new customer, the user selects an add new customer tab 206 that prompts the user to input information for the new customer, such as contact information and interests.

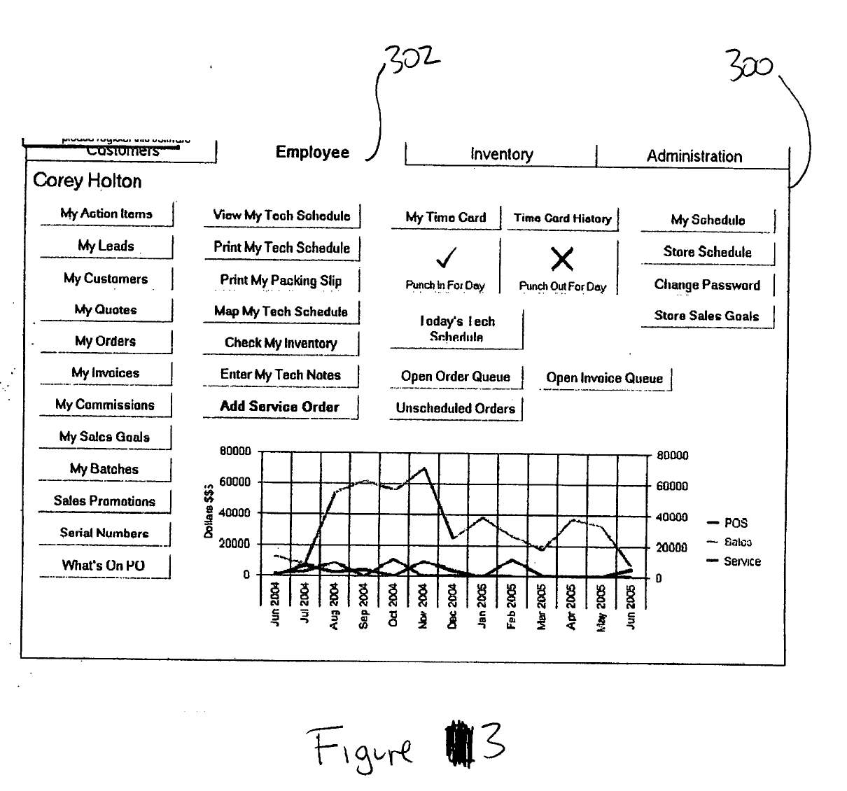

FIG. 3 illustrates a main menu 300 for the employee component of the program 104. A tab 302 is selected from any of the other main menus to select the main menu 300 for the employee component. An employee of the business accesses the program 104 through the main menu 300 and utilizes various portion of the menu depending on the type of employee. A sales employee will utilize the buttons in the far left column of the main menu 300. As seen from the names of the buttons in this column, a salesperson can access leads and customers assigned to that person simply by selecting the corresponding tabs. The second column of buttons from the left are typically used by service employees, and enable such an employee to perform desired actions like check and printing his or her schedule and printing packing slips of parts needed for service calls.

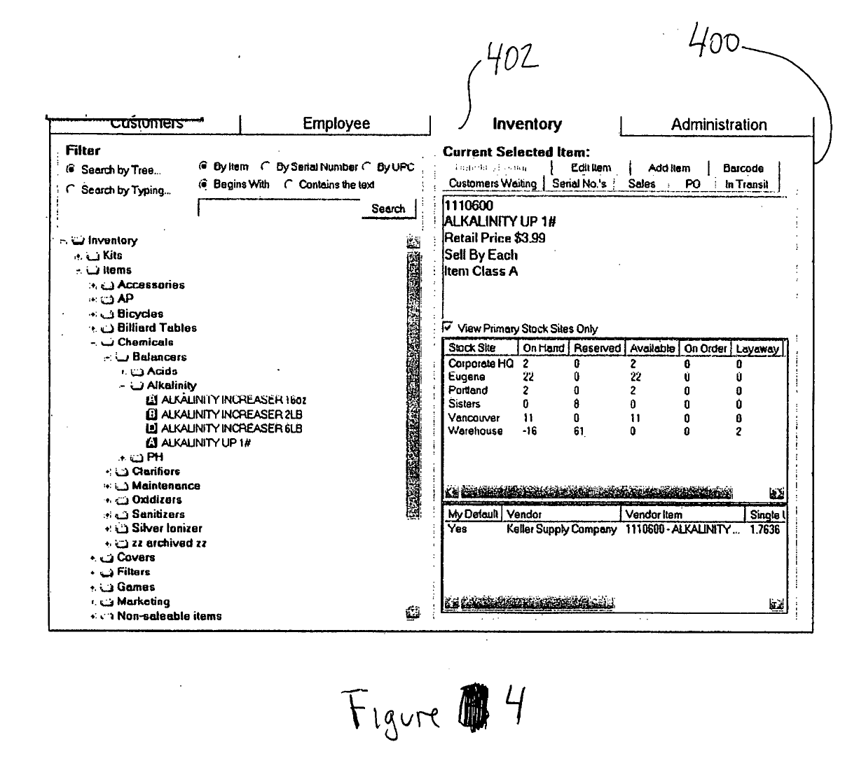

FIG. 4 illustrates a main menu 400 for the inventory component of the program 104. Once again, a tab 402 may be selected from any of the other main menus to select the main menu 400 for the inventory component. Employees and managers of the business can access the inventory main menu 400 to determine how many of a desired item are presently in inventory and how much does the item cost. While all users of the program 104 may have access to the inventory main menu 400, only authorized personnel can update or add items or quantities of items. The left portion of the inventory screen illustrates an inventory tree that allows a user to easily browse through the current inventory. Folders categorize items and when a folder is opened inventory items within that folder are shown as boxes. When a given inventory item is selected, more detailed information about that item is depicted in the upper right hand portion of the menu 400. Just below this more detailed information about quantities of the selected inventory item are shown for all locations of the business.

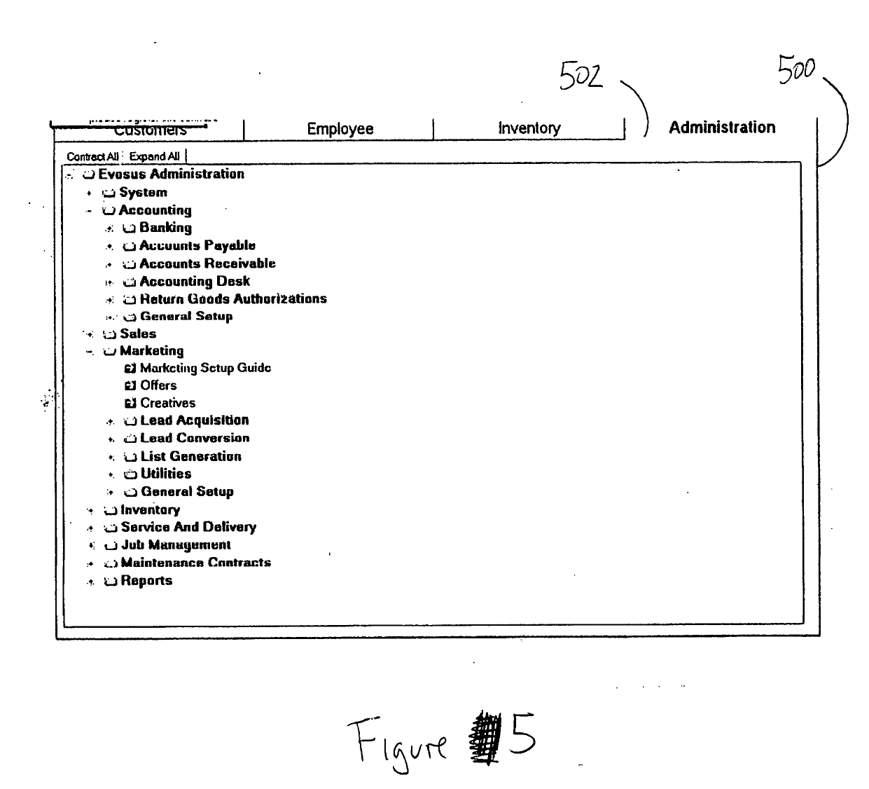

FIG. 5 illustrates a main menu 500 for the administration component of the program 104. Once again, a tab 502 may be selected from any of the other main menus to select the main menu 500 for the administration component. The administration main menu 500 is accessible by managers and other select personnel to handle other important aspects of the business, such as accounting, sales management, marketing, and service and delivery. These and other aspects are selected through corresponding folders shown on the left side of the administration menu 500. Access to each of these folders is secured such that personnel only have access to folders required to perform his or her job. For example, the accountant of the business may be provided access the accounting folders but not the service and delivery folders while the service manager may be provided access to the latter but not the former.

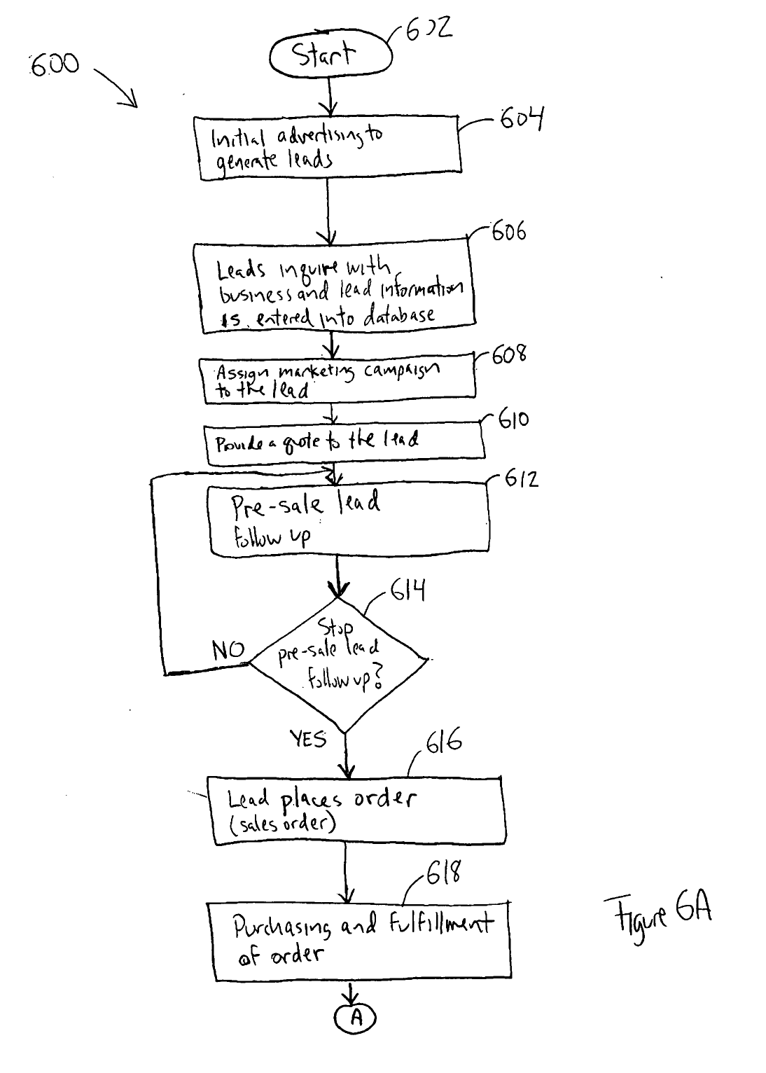

FIGS. 6A and 6B depict a flowchart of a lead-to-income statement process 600 executed by the business management computer program 104 of FIG. 2 according to one embodiment of the present invention. The process 600 begins in step 602 and proceeds to step 604 in which initial advertising is performed to generate leads. The leads in step 604 can be generated through lists from the program 104, as will be described in more detail below. The term “leads” is used in the present description to mean a person or entity that has expressed an interest in a product or service of the business the program 104 is being used to manage, with a lead becoming a customer after having purchased a product or service. The advertising may be done in any of a variety of known channels, such as through newspaper ads, television commercials, radio commercials, and tradeshows.

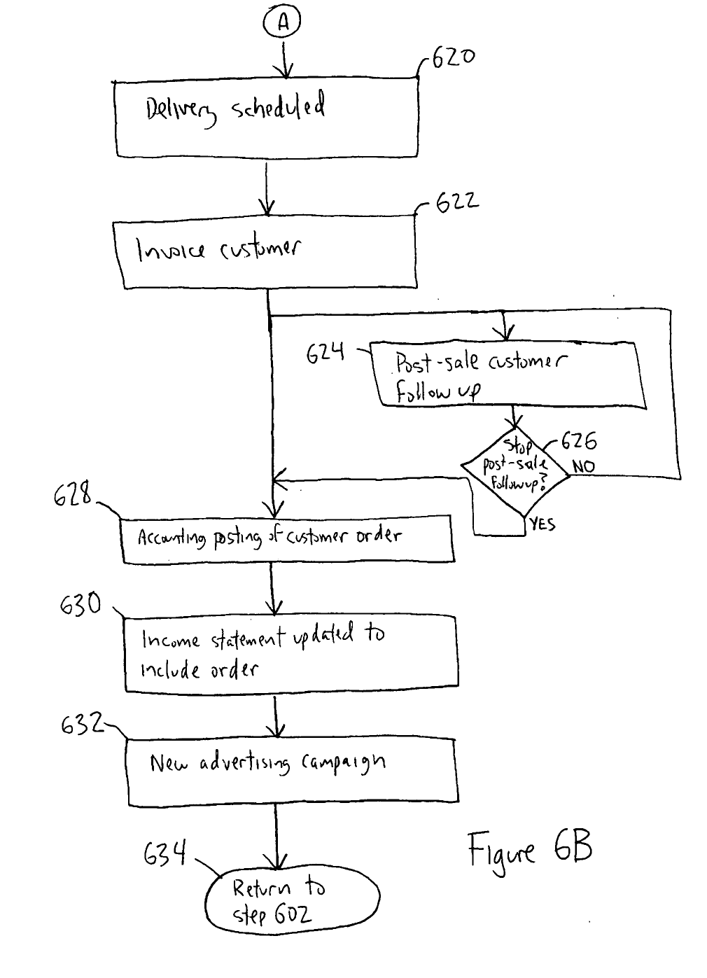

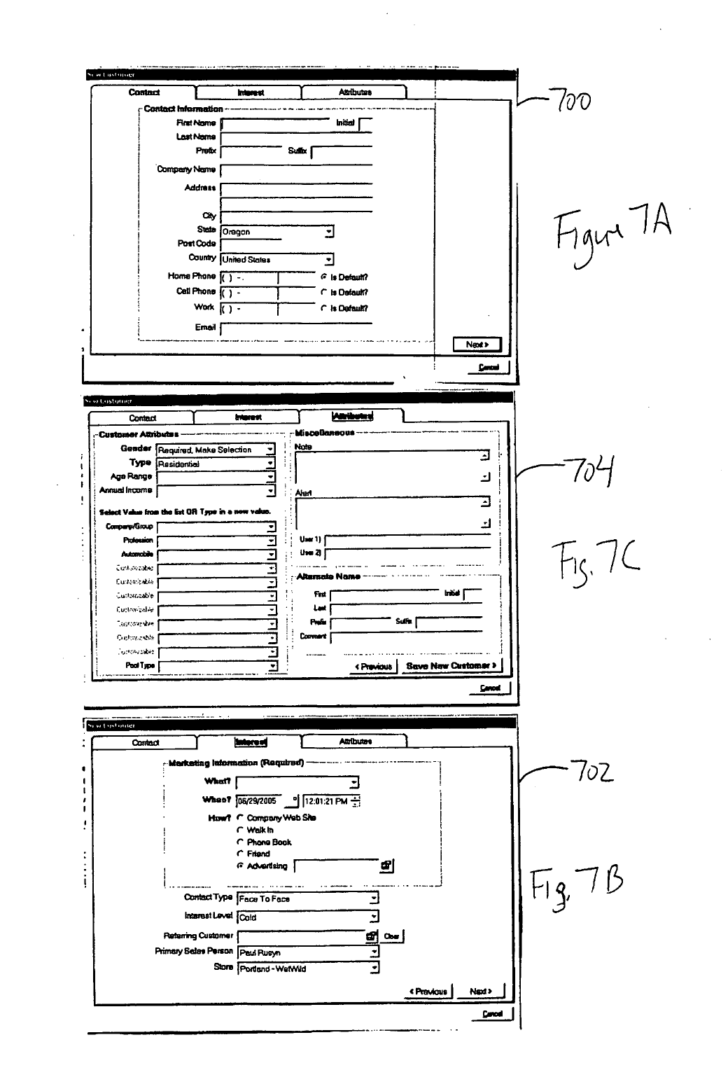

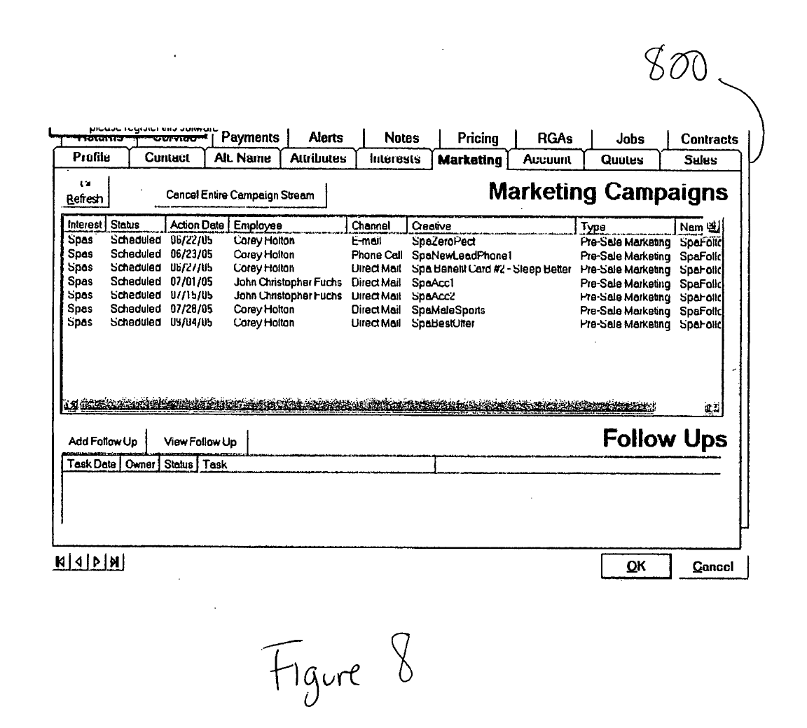

From step 604 the process 600 goes to step 606 in which leads generated through the advertising of step 604 inquire in some way with the business. Such inquiries could be through a telephone call, by accessing a Web site of the business, or by coming into a store of the business. Regardless of how the lead inquires with the business, key information about the lead is input to the program 104 in step 606 to allow the program to execute the lead-to-income statement process 600. In one embodiment of the process 600, this key information includes contact, marketing, demographic, and business information for the lead making the inquiry. Contact information includes the name, address, phone number, and email address of the lead, which a user inputs to the program 104 via the window 700 shown in FIG. 7A.

The user inputs marketing information for the lead through the window 702 of FIG. 7B, which is accessed via the interest tab at the top of the window 700 of FIG. 7A. The window 702 includes a “what” field corresponding to the product or service about which the lead is inquiring, and fields for the date and time of the inquiry. An advertising code AC is a code defined in the computer program 104 and assigned to each advertising campaign undertaken for the business, and the user enters the advertising code from which the lead originated an advertising field in the window 702. Advertising codes AC enable the program 104 to generate pertinent business information related to the advertising campaigns, such as “cost-per-lead” defined as the number of leads generated by a given advertising campaign divided by the number of leads generated by the advertising campaign. Demographic information about the lead is input through a window 704 as shown in FIG. 7C, which is accessed via an attributes tab at the top of the windows 700, 702. The demographic information includes gender, type (residential or commercial), age range, and annual income information.

After this information for the lead is input to the program 104, the process 600 proceeds from step 606 to step 608 and the program assigns a marketing campaign stream to the lead. A marketing campaign stream is a series of steps for following up with the lead on a predetermined schedule. The business owner or other authorized personnel of the business defines marketing campaigns in the program 104. The program 104 assigns a marketing campaign stream to each lead based upon the interest, advertising code AC, demographic information, and business information for the lead, as input to the program via the windows 700-704 of FIGS. 7A-7C. Marketing campaign streams are defined under the administration tab 502 in the administration main menu 500 of FIG. 5, and include such information as schedule follow up times and dates and the type of follow up (e.g, email, telephone call).

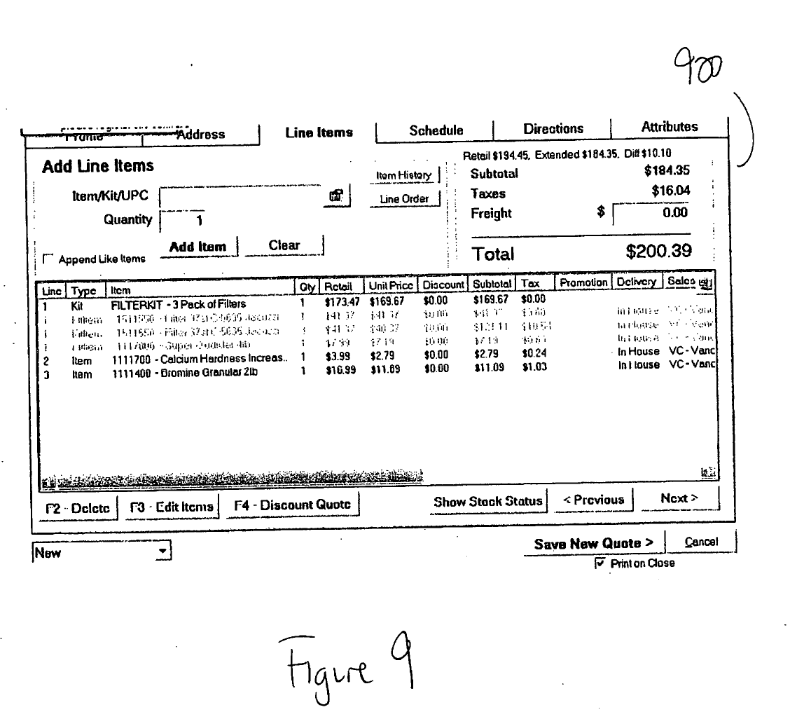

FIG. 8 illustrates a window 800 showing the follow up steps of a sample marketing campaign stream. The example of FIG. 8 is for a pre-sale marketing campaign stream, meaning it is for a lead as distinguished from a post-sale marketing campaign stream directed to an existing customer, as will be explained in more detail below. Each follow up step or action has an associated “creative” as shown in FIG. 8. A creative is something that is presented to a customer in some form and in this way is a contact point between the business and the lead. In the example of FIG. 8, the first creative in the top or first action is an offer for zero percent interest financing, the action in the second line is an initial follow up phone call, and so on, with each action having an associated creative.

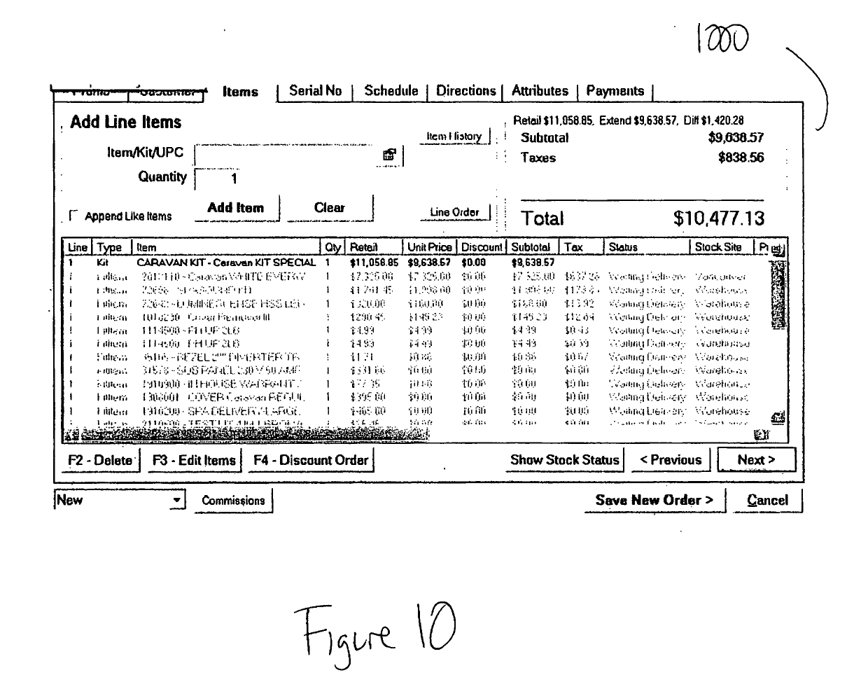

From step 608 the process 600 goes to step 610 and a user provides a quote to the lead for the products or services of interest. FIG. 9 is illustrates a window 900 presented to a user for providing a lead with a quotation in step 610. Items of interest are added via fields in the upper left portion of the window 900 and dollar values shown in the upper right and a list of all items along with associated descriptions, costs, and availability shown in the lower portion of the window. Upon input of the lead to the program 104, a quote need not be but may be provided to the lead in step 610.

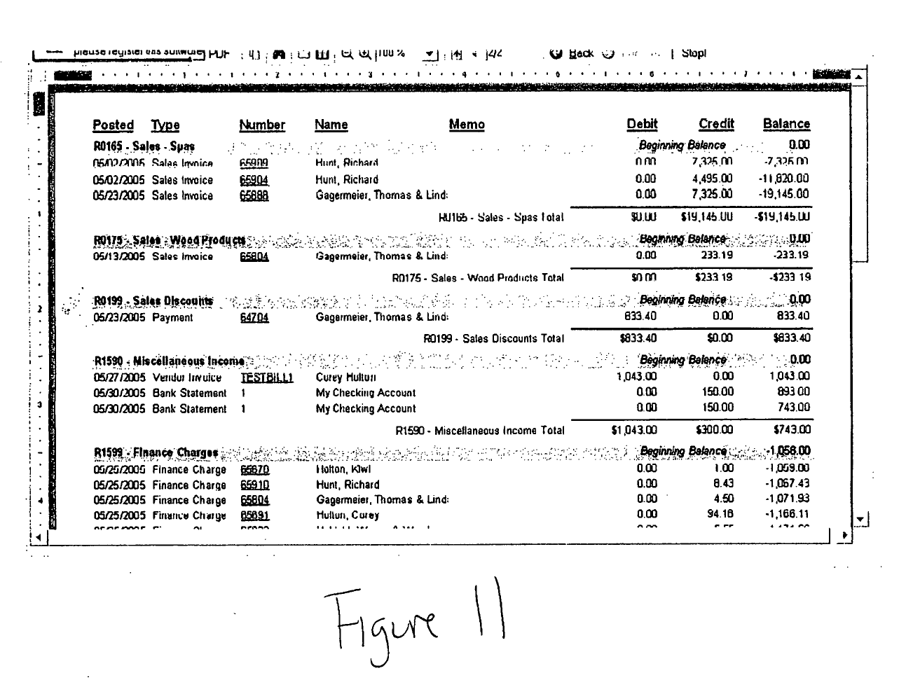

After any quote provided in step 610, the process 600 goes to step 612 and executes the pre-sale lead follow up process defined by the marketing campaign stream assigned to the lead. Thus, in step 612 sales personnel within the business perform the steps in the assigned marketing campaign stream, such as in the sample campaign stream of FIG. 8. Personnel thus call, email, and/or direct mail the lead per the assigned schedule and with the creative associated with each such follow up action. From step 612 the process goes to step 614 and determines whether the pre-sale follow up process or campaign stream for the lead should be terminated. If the determination in step 614 is negative, meaning the lead has not yet purchased a product or service but the campaign stream should continue, then the process goes back to step 612 and the follow up process continues. When the determination in step 614 is positive, the lead has decided to purchase a product or service and the process goes to step 616 and a sales order is generated. At this point, the lead is now a customer. FIG. 10 is an example of a window 1000 showing the generation of a sales order in step 616. The sales order shows each of the items in the order along with a variety of information for each item, such as the status of each item (in stock, awaiting deliver, etc.) and the location at which the item is stocked.

With regard to step 614, note there are other reasons the pre-sale campaign stream of step 612 may be terminated, such as the lead requesting no further follow up from the business or all actions in the stream have been performed and the lead still has not purchased a product or service. In either of these two situations, information for the lead is maintained in the database of the program 104 for historic purposes or for use in future advertising campaigns.

After generation of the sales order in step 616, the process goes to step 618 and purchasing and fulfillment of the order are performed. Upon the sales order being generated in step 616, the program 104 automatically notifies purchasing and fulfillment personnel of the new order so that these personnel can take appropriate actions. The program also indicates whether items to fulfill the sales order are already in stock or whether items need to be purchased from a supplier, and thus prompts purchasing personnel of required actions. In step 618, the program 104 generates required purchase orders for the appropriate suppliers and personnel email or fax such orders to the suppliers. The program also generates links between the items on the purchase order and the customer for which those items have been ordered, which allows sales personnel to tell the customer when items will arrive. When the items on the purchase order are received, the program 104 notifies the responsible sales personnel so that these personnel can, in turn, notify their customers that their items can now be delivered or are available for pick up.

From step 618 the process goes to step 620 and the program 104 generates a delivery or pick up schedule for all ordered items, assuming such items are to be delivered. The program 104 has particular utility in the pool and pa industry and in this case the purchased product may be, for example, a hot tub. Once all items on the sales order of step 616 have been received, delivery and typically installation of the spa are scheduled. The program 104 assigns delivery and installation to appropriate personnel and vehicles, and allows such personnel to print copies of the order to ensure all items are being delivered.

Once all items have been delivered and installed in step 620, the order is complete and the process 600 goes to step 622 and invoices the customer for the order. If full payment has been received, the invoice can simply be closed and if not the program notifies accounting and they will begin invoicing the customer for payment of the product.

After step 622, the process 600 initially goes to step 624 and initiates a post-sale follow up on the customer, which is alternatively referred to as a post-sale campaign stream. This is analogous to the pre-sale campaign stream of step 612 except that the actions are directed towards a customer and not a lead as in step 612. Thus, actions may be directed to selling service of the purchased product such as a spa to the customer, or to getting the customer purchase related accessory items. As in the pre-sale campaign stream situation, all actions in the post-sale campaign stream have an associated creative and are prescheduled as part of defining the campaign stream. As in the case of a pre-sale marketing campaign stream, the program 104 assigns a post-sale marketing campaign stream to the customer based upon the interest, advertising code AC, demographic information, and business information for the customer. It should be noted that multiple post-sale and pre-sale campaign streams can be assigned to a customer.

From step 624 the process goes to step 626 and determines whether the post-sale follow up process or campaign stream for the customer should be terminated. If the determination in step 626 is negative, meaning the customer has not yet purchased the additional product or service being offered but the campaign stream should continue, then the process goes back to step 624 and the follow up process continues. The determination in step 626 can be positive for a number of different reasons, and when this is true the process goes to step 628. The first instance where the determination in step 626 is positive is when the customer has decided to purchase the additional product or service. A second instance is where the customer has requested no further follow up from the business or when all actions in the post-sale marketing campaign stream have been performed and the customer still has not purchased the additional product or service. In either of these two situations, information for the customer is maintained in the database of the program 104 for historic purposes or for use in future advertising campaigns. When the determination in step 626 is positive because the customer has decided to purchase the additional product or service, the corresponding order, purchasing and fulfillment, delivery, and invoicing of the customer occur in the same way as previously described in the steps 616-622, respectively, for the initial order of the customer.

In step 628, the program 104 automatically initiates the posting process for accounting. Note that after invoicing of the customer in step 622 the process 600 also goes directly to step 628 to post the initial order by the customer with accounting. Typically, after invoicing in step 622 the process goes to step 628 and the order is posted to accounting and, in parallel, after step 622 the steps 624 and 626 initiate the post-sale campaign stream to sell additional products or services to the customer. At some later date this post-sale campaign stream is hopefully successful and, only at this point, is this subsequent order placed and then subsequently posted to accounting in step 628. Posting of the order in step 628 includes revenues, cost of goods sold, and payment being posted to a general ledger generated by the program 104.

Once an order has been posted in step 628, the process 600 goes to step 630 and the program 104 generates a new income statement that includes items associated with the order just placed. FIG. 11 illustrates a sample income statement generated by the program 104. Once an order has been invoiced, data for this order is automatically included in the next income statement generated by the program 104. The program 104 can also generate additional reports from specific parameters provided by a user, such as additional sales reports that can further break down the revenues and costs associated with the order and all orders for a given day, for example, based upon the advertising codes associated with each order. This enables the business owner and marketing personnel to determine return on investment for advertising dollar spent.

From step 630, the process goes to step 632 and a new advertising campaign is initiated. Such a campaign will result in new leads and the process 600 then goes to step 634 and returns immediately to step 602 and starts over. The program 104 also enables a user to utilize the database generated by the program to generate leads for a new advertising campaign, such as a list of leads in the database that have not purchased a product or service.

Referring back to FIG. 1, a sales order may be input to the program 104 at any time, such as when a customer in a store wants to purchase an item, and thus the program may be termed as operating in a point of sale mode. Thus, the single computer system 100 executing the program 104 may be used for multiple functions, being a point of sale terminal in one instance and being used by a sales person the next to follow up with leads as part of the process 600, as well as being used by a manager to define campaign streams, for example. Although not shown in FIG. 1, the program 104 is typically run in a networked environment with multiple computer systems interconnected via network and users logging into and out of the program as required.

Even though various embodiments and advantages of the present invention have been set forth in the foregoing description, the above disclosure is illustrative only, and changes may be made in detail and yet remain within the broad principles of the present invention. Therefore, the present invention is to be limited only by the appended claims.

[image]

[image]

[image]

[image]

[image]

[image]

[image]

[image]

[image]

[image]

What is claimed is:

1. A method of tracking inventory items purchased under a financing plan, each item having an associated serial number, the method comprising:
define a floor plan associated with inventor items being purchased under a financing plan;
tag purchase order associated the items;
receive items and record serial numbers associated with the received items;
receive invoice for purchased items; and
tracking inventory items in real time via a single finance plan search screen.
